(19) United States
(12) Patent Application Publication
(10) Pub. No.: US 2009/0110906 A1
(43) Pub. Date: Apr. 30, 2009

(54) BUBBLE-FREE BONDING ADHESIVE COATING

(75) Inventors: Klaus Kleinhoff, Rodenberg (DE); Jochen Fiencke, Hamburg (DE)

Correspondence Address: NORRIS, MCLAUGHLIN & MARCUS, PA, 875 THIRD AVENUE, 18TH FLOOR, NEW YORK, NY, 10022, US

(73) Assignee: Tesa AG, Hamburg (DE)

(21) Appl. No.: 12/297,497

(22) PCT Filed: Apr. 4, 2007
(86) PCT No.: PCT/EP2007/053291

§ 371 Date: Dec. 9, 2008

(30) Foreign Application Priority Data
Apr. 19, 2006 (DE) 102006018492.0

(51) Int. Cl. B32B 3/26; B29C 65/48

(52) U.S. Cl. 428/313.3; 156/60

(57) ABSTRACT

Bubble-free bonding adhesive coating with a bonding material and a channel element, whereby the channel element is formed, at least temporarily, with a fitted cavity for the transportation of fluids, the channel element hereto has one thread entity with at least one thread, the channel element and the thread entity are fundamentally parallel to the extent of the surface and aligned with the adhesive coating, and a section of the surface of the thread entity forms a section of the surface of that side of the adhesive coating that is the bubble-free bonding adhesive surface of the adhesive coating.

The invention relates to a bubble-freely bonding adhesive layer with an adhesive and with a channel element, to the use of the adhesive layer to produce a bubble-free bond, to the use of the adhesive layer to produce a bubble-freely bonding sheetlike structure, to methods of producing the bubble-freely bonding sheetlike structure, and to the bubble-freely bonding sheetlike structure thus produced.

Numerous applications employ sheetlike adhesive articles such as, for instance, adhesive sheets or adhesive tapes which are applied to a substrate or base for the purpose of joining it adhesively to other elements in order to protect them or for decorative purposes. Such adhesive articles have, on one side or on both sides, adhesive layers (i.e., sheetlike adhesive laminae or adhesive films) comprising adhesives by means of which the adhesive article is to be attached to the substrate.

A frequent occurrence during the bonding of the adhesive articles, however, is the inclusion of air at the bond face (i.e., at the face of the adhesive bond between the adhesive on the one hand and the substrate on the other), where the air remains as a bubble. This occurs in particular when adhesive contact between the adhesive article and the base is not produced starting from a single point or from a line without circular closure and then extending over the entire bond face. Indeed, if adhesive contact were to be produced in the form of a closed curvilinear line, the adhesive side of the adhesive article in the interior of this curvilinear line being not yet in contact with the substrate, the air would be locally included there.

The formation of bubbles in this way becomes all the more frequent as the bond face increases in size. It is indeed frequently still possible for the adhesive regions which lie outside the closed curvilinear line to be bonded to the base without bubbles. However, the air located in the interior of the bond-face ring is included and also, usually, cannot be taken off perpendicularly to the bond face, since frequently neither the substrate to be bonded nor the carrier materials of the adhesive article are of air-permeable design.

Air inclusions or air bubbles of this kind are unwanted in the majority of adhesive bonds. Bubble-free (i.e., full-area) joining is particularly important in the case of those adhesive bonds which are required to have a technically uniform height (such as when fixing printing plates in the printing industry, for instance), or for which the visual quality of the adhesive bond is important (as in the case, for instance, of protective films on optical devices, or decorative covers made of adhesive sheets).

As a consequence of the requirements imposed on the geometry and the carrier material of the adhesive articles, it is difficult to ensure a bubble-free bond at the stage where the bond is formed. It is sensible, accordingly, to be able to generate an absence of bubbles from the bond in a bond aftertreatment procedure, in which the air bubble is removed from the bond face. The most common aftertreatment measure is represented by pressing out the bubble. In this case the air inclusion is moved, by the exertion of a pressure on the top side of the air bubble, toward the edge of the bond face. For this purpose, however, it is necessary for the adhesive contact that has already been formed of the region around the bubble to be parted again, in regions, and this is successful only in the case of weak adhesive bonds. A disadvantage is that a relatively large force must be applied in order to transport the air bubble beneath the sheetlike bonding face to the edge. For complete transport, therefore, a vigorous “pressing out” is needed in order to overcome the resistance presented by the already-bonded bond face to the air inclusion. Even then, however, there is frequently damage to the substrate or to the adhesive article (or there is neutralization of the adhesive).

To simplify the aftertreatment in the form of pressing out, therefore, bubble-freely bonding adhesive articles (i.e., adhesive articles which are applied to the substrate and bond to it, the bond, without aftertreatment or possibly after simple aftertreatment, exhibiting no air bubbles included in the bond face) are used for which the adhesive has permanently uninterrupted channels with a low cross-section area. Since these channels are to be situated at what is subsequently the bond face, they are typically located on the side of the adhesive that is brought into contact with the substrate for the purpose of bonding. The channels enable the air that is included at the bond face to be passed to the edge of the bond face, without transport through these channels requiring that a joint already produced between the adhesive article and the substrate be parted locally and bonded again after an air bubble has been pressed through. Transport through the uninterrupted channels, accordingly, is “soft pressing out”, in other words a low-pressure or even virtually pressure-free pressing-out procedure where only low pressure need be applied. The facilitation of pressing out derives, accordingly, from the fact that the greatest part of the distance the air bubble must travel along the bond face is overcome with low resistance, i.e., by means of only gentle pressing out. For transport over the short distance which the air bubble must travel in order to achieve the closest channel, therefore, there is still a need for forceful pressing out, for which an adhesive bond that has already come about is parted and re-established. Since the latter distance is generally shorter than the first distance, it is possible to remove the air bubble that has occurred during bonding with application of a pressure which, overall, is low. The use of bubble-freely bonding adhesive articles of this kind, and methods of producing them, are disclosed, for instance, by EP 0 951 518 B1.

A disadvantage of such systems is that the adhesive used must be sufficiently dimensionally stable, since the channels must be uninterrupted just a short time after the bonding of the adhesive article to the substrate. It is therefore only possible to use “hard” adhesives, in other words highly cohesive adhesives with only small viscous fractions, since otherwise there would be a risk that the channels, owing to a viscous flow—as for instance when the adhesive article is pressed onto the substrate—could be permanently closed and would no longer be accessible to transport of the air bubbles toward the edge of the adhesive article. Hard adhesives of this kind, however, frequently exhibit low levels of adhesion and tack.

The prior art (DE 198 35 919 A1) also discloses a self-adhesive sheet for the bonding of carpets, in which a thread structure is embedded in the adhesive layer of the self-adhesive sheet. This thread structure serves to maintain the dimensional stability of the self-adhesive sheet during laying and detachment. The problem of the bubble-free bond does not exist with this kind of self-adhesive sheet, since, on adhesive bonding, the fluid is able in any case to escape perpendicularly to the two-dimensional extent of the adhesive layer, through the air-permeable carpet.

Also known from the prior art (DE 90 02 466 U1) is an electrically conductive sheetlike structure in which electrical leads in the form of wires are partially embedded in the adhesive layer and partially exposed for the purpose of contacting at the surface of the adhesive layer. The electrical leads are arranged in two groups, which cross one another and run alternately over and under one another.

It is an objective of the invention to provide a bubble-freely bonding adhesive layer which permits the use of an adhesive possessing high adhesion, more particularly the use of a pressure-sensitive self-adhesive composition. In pursuing this objective, the problem addressed by the inventors was that of providing a channel element with which any air inclusions generated on the substrate in the course of bonding can be removed easily even when the adhesive layer has been applied to the substrate with strong pressure. A further problem was that of providing the use of an adhesive layer to produce a bubble-free bond; a bubble-freely bonding sheetlike structure having a functional region and an adhesive region joined to the functional region; the use of an adhesive layer to produce the sheetlike structure; and a method of producing the sheetlike structure.

It has surprisingly been possible to solve the problem by means of a bubble-freely bonding adhesive layer with an adhesive and with a channel element, where the channel element is so formed as to have at least temporarily a hollow space adapted for the transport of fluid, where the channel element comprises for this purpose a thread structure with at least one thread, where the channel element and the thread structure are oriented substantially parallel to the two-dimensional extent of the adhesive layer, and where a part of the surface of the thread structure forms a part of the surface of the side of the adhesive layer that is the bubble-freely bonding adhesive face of the adhesive layer.

The thread structure, then, is disposed in such a way that it is not completely embedded in the adhesive and covered by it, but instead is itself involved in forming the surface of the bond face. Provision is made, moreover, for the channel element and hence also the thread structure to extend substantially parallel to the two-dimensional extent, in other words continuously along the surface, thereby allowing fluid transport by means of the channel element along the surface of the adhesive layer.

The fact that a part of the surface of the thread structure forms part of the surface of the side of the adhesive layer that is the bubble-freely bonding adhesive face of the adhesive layer ensures, in addition to the inventive adaptation, that transport takes place via the channel element in the bonding plane itself—the bond face—or at least immediately adjacent thereto, with the result that a bubble of fluid at the bond face need not be first pressed through part of the adhesive layer in order to reach the hollow transport system of the thread structure of the channel element. A design of this kind can be achieved by the thread structure not being embedded completely in the adhesive but instead having at least part of its surface finishing flush, or even protruding beyond, the surface of the adhesive. The protrusion option is favorable more particularly for substrates having a yielding or soft surface structure.

It has been found that threads of cotton exhibit a hollow space suitable for the transport of fluid, even without additional adaptation steps, if it is ensured that they are inserted into the adhesive in such a way that, toward the bond face, the threads are not covered with adhesive but instead lie free.

The adhesive layer is a carrierless, substantially two-dimensional arrangement comprising an adhesive as its principal constituent. An adhesive typically comprises at least one adhesion-generating component, which may in turn have different constituents, such as tackifier resins and structure-controlling constituents such as plasticizers, crosslinkers or crosslinker assistants. The adhesive may further comprise adjuvants such as colorants, fillers or expanders. In accordance with the invention it is possible to use any typical adhesive, examples being thermally activable adhesives, but preference is given to employing pressure-sensitive self-adhesive compositions, in which a bond with the substrate is achieved generally simply by the exertion of gentle pressure on the adhesive (and/or its carrier). Pressure-sensitive self-adhesive compositions of this kind, which enter into a bond to the base immediately they are brought into contact with it, are also referred to in abbreviated form as PSAs. A pressure-sensitive self-adhesive composition of this kind may be, for example, a solventborne adhesive, dispersion-based adhesive, curing hot melt adhesive and/or noncuring hot melt adhesive, use being made more particularly of hot melt adhesives (or simply hot-melts) and adhesives based on polyacrylates, on elastomers (thermoplastic and nonthermoplastic) or on polyurethanes (one-component or multicomponent).

The adhesive layer further comprises at least one channel element. Where a gaseous or liquid fluid such as air or water is included between the adhesive layer and the substrate during bonding at the bond face, and forms a bubble, the channel element makes it possible for this fluid to move from the interior of the adhesive layer to the edge of the adhesive layer. Transport of fluid (i.e., fluid dissipation) through the adhesive layer is normally brought about by the generation, between the interior and the exterior of the fluid-filled bubble, of a pressure difference, in the form for instance of an external pressure in the case of pressing-out, as a consequence of the intrinsic tension of the adhesive layer (and/or of an additional carrier), or when a vacuum is applied to the volume outside the bubble. As a result of this pressure difference, the fluid that is present within the bubble is taken off within the channel element in the direction toward the site of lower overall pressure. The result of this is that a fluid bubble which comes about during adhesive bonding can be removed from the territory of the bond via a channel structure, in a simple way, since the transport of the fluid bubble along the channels does not necessitate the parting and re-forming of an existing bond of the adhesive layer to the substrate, of the kind required, for instance, by forceful pressing-out. It will be appreciated that it is also possible to incorporate more than one such channel element in an adhesive layer, in order thereby to ensure particularly efficient transport of fluids.

In accordance with the invention the channel element comprises a thread structure. A thread structure of this kind comprises at least one thread, the term “thread” representatively encompassing all typical designations of a flexible structure which has a low transverse extent in relation to its longitudinal extent; in other words likewise fibers, yarns, ropes, cables, twines, and the like, provided they have the correct dimensions. Likewise embraced are, for example, those structures having regular or irregular cross sections, having polygonal, circular or other—elliptical, for example—cross sections and/or having full-area or hollow cross sections, rigid or compressible.

Depending on the amount of fluid to be taken off it is favorable here for the threads to be formed as monofilaments, i.e., in single-fiber form, in other words monofil. This offers the advantage of being able to carry out any chemical or mechanical modifications to the surface that are needed in order to adapt a thread of the thread structure in respect of the at least temporary presence of a hollow space right at the stage of manufacturing the thread, such as during the spinning of a manmade fiber, and hence of avoiding the need for additional aftertreatment. Monofilaments of this kind are contemplated more particularly for small volumes of fluid to be taken off.

It is likewise favorable, however, to form the threads as polyfilaments, i.e., in multifiber form or polyfil, it being possible for the individual fibers to have a mutually parallel alignment or a twisted, intermeshed or similar arrangement. By this means it is possible to obtain an optimum of structural stability for a minimum of deployment of material, so that very large volumes of fluid can be taken off easily. Materials to be used for such threads are all the usual materials—for instance, natural fibers such as those of cotton, silk, and wool (the latter with or without lanolin), synthetic fibers such as those of rayon, polyaramid, nylon or polyamides and other polymers, inorganic fibers such as those of rockwool or glass fibers, or else composite fibers, comprising mixtures cellulose with other fibers, for instance.

The channel element is, further, oriented substantially parallel to the two-dimensional extent of the adhesive layer and hence also to the bond face. This means that the orientation of the space structures in the channel element is such that the thread, or the individual threads, is or are arranged substantially parallel to the plane in which the bonding of the adhesive layer on the substrate takes place. This arrangement avoids the situation of the fluid, in the course of transport from the interior of the bond face to the edge of the adhesive layer, traveling paths which require a movement perpendicular to the bond face. As a result, fluid transport out of the adhesive layer is additionally facilitated.

It is key to the invention that the channel element is specially designed, so that it has, at least temporarily, a hollow space adapted for the transport of fluid; in other words, a hollow transport structure. As an inventive adaptation, any adaptation is possible which allows a bubble of fluid located in the interior of the bond face to be transported in an at least temporarily generated hollow space along the channel element to the exterior of the adhesive layer, such as the use of a particular geometric structure, a surface modification of the threads, or else an adaptation of form and material of the threads with respect to the properties of the adhesive.

In addition, however, the adaptation must result in the at least temporarily generated hollow space being accessible from the bond face, hence allowing the fluid to penetrate from the bond face directly into the hollow space without having for that purpose to pass directly through the adhesive itself. This can only be achieved when, on the side of the adhesive layer which is part of the bond face within the bond, the thread structure is not fully embedded in the adhesive and covered by it, but instead lies at least partly free. In this context it is particularly advantageous if the threads from the thread structure lie completely free over their entire longitudinal extent along the principal thread direction. An adaptation of this kind is absent from the existing adhesive tapes with individual threads in the adhesive, as disclosed, for instance, by U.S. Pat. No. 2,750,315 for the purpose of improving the structural stability of the adhesive tape, since there the threads are fully embedded in and surrounded by the adhesive, meaning that fluid transport out of the bond face to the hollow spaces that are possibly present there is not a possibility.

A separate adaptation of the channel element is important in addition for the reason that, absent this adaptation, fluid transport parallel to the bond face is not possible, or at any rate is more difficult. Where, for example, polyfil threads are embedded into an adhesive without separate adaptation thereof, the resulting adhesive layer does indeed initially have fine hollow spaces. However, if the slightest pressure is exerted on such systems, the hollow structure collapses, since it is penetrated by adhesive and the transport of fluids out of the bond face is no longer possible.

A temporarily generated hollow space is formed, for instance, when the threads of the thread structure in the channel element are arranged at the surface of the adhesive layer in such a way that, in the course of bonding, part of the surface of the threads comes into contact with the substrate, but without bonding to the substrate. The hollow space suitable for fluid transport comes about only when a bubble of fluid is to be transported along the channel system of the channel element, and in fact comes about locally between the thread and the substrate, but has disappeared again after the volume of fluid has passed through the hollow space. Fluid transport through a temporary hollow space of this kind does not require the opening or re-bonding of existing adhesive bonds. If this hollow space comes about only when there is a bond to the substrate and additionally a bubble of fluid is moved, and if it is no longer present after the bubble of fluid has passed (but the channel element is still adapted to form the hollow space), it is generated temporarily. In this case an inventive adaptation consists in equipping the part of the surface of the threads that is disposed on the surface of the adhesive layer in such a way that the threads themselves do not bond to the substrate. It is of course also possible for the threads to be equipped such that the adhesive does not attach to them, as a result of which, during transport of a fluid, a temporary hollow space could ensue between the thread structure and the adhesive layer not attaching to the thread. Both can be achieved, for example, if, at the corresponding parts of the threads—in the first case locally, at one part of the surface; in the second case, on the entire surface area of the threads—an adhesion-reducing substance is applied or said surface is itself given an adhesive-reducing modification there, as for example by siliconization.

It is, however, particularly preferred for the channel element to be so formed as to have, permanently, a hollow space adapted for the transport of fluid. A permanently present hollow space of this kind exists when, at the adhesive bond, the adhesive layer permanently has a hollow space which does not come about only during the passage of the fluid. A permanently present hollow space of this kind exists, for instance, when the threads of the thread structure have permanently present and permanently uninterrupted hollow structures, such as hollow spaces on their inside or concave depressions on their top face, for example, which within the adhesive layer are free of adhesive and so permit fluid transport. Via the adaptation of the layer to form permanent hollow transport structures, it is possible to move particularly large volumes of fluid along the bond face in a simple way, in the case for example of particularly large or irregularly shaped substrate surfaces. Natural polyfil yarns, more particularly those of cotton, frequently provide a fluid removal promotion effect of this kind without additional adaptation steps, provided it is ensured that they are inserted into the adhesive in such a way that the threads, toward the bond face, are not covered with adhesive, but instead lie free. Consequently thread structures comprising such threads are particularly preferred.

For the implementation of the invention it is possible for the thread structure to be composed of just a single thread. A single thread has the capacity to facilitate fluid transport by virtue of the fact that a bubble of fluid must no longer be pressed along the bond face, with parting and re-bonding of the join of the adhesive layer to the substrate, but need only be moved to the thread, at which the fluid can be transported via the hollow transport structure of the thread, under gentle applied pressure, to the edge of the layer. Even when a single thread is used, the pressing-out of a bubble of fluid occurring within the bond face is made much easier overall, since the bubble must only be moved a small distance by means of forceful pressing-out, while the major part of the distance takes place in the form of transport along the channel element, with gentle pressing-out.

Particularly in the case of the transport of relatively large volumes of fluid, however, it is desirable to minimize the distance to be overcome by means of forceful pressing-out. This can be achieved by increasing the density of the threads per sheetlike element, so that the path to be traveled on average to the next thread of the thread structure is decreased. Accordingly it is particularly advantageous if the thread structure in the channel element of the adhesive layer has a plurality of threads which are disposed in parallel with one another and/or which cross one another. A thread structure of this kind, comprising a plurality of threads, is frequently contained within a looser fabric, in the form for example of a cord fabric. This is of course equivalent to the use of a thread structure composed of just a single thread when that thread is passed a number of times over the area of the adhesive layer, such as in parallel-aligned or in mutually intersecting paths.

In the case of the parallel threads or thread paths (“cord mode”) an arrangement with a constant spacing is sensible. For reasons of bonding stability and of production costs, this spacing ought to be chosen to be as large as possible—and at the same time as small as is necessary for simple fluid removal. In practise, depending on application, spacings of between 0.7 mm and 7.0 mm have emerged as being sensible. Hence, for the majority of applications, a thread spacing of 1.5 mm has given the best results; for strongly adhesive compositions, however, with a particularly pronounced wetting behavior, this spacing should be chosen to be smaller.

In a further favorable embodiment, the hollow space is disposed in each case on the outside of the at least one thread. The advantage of this is that particularly large volumes of fluid can be transported via the channel system of the channel element in this case. An embodiment of this kind on the outside of the thread can be realized in all of the usual ways: for instance, by applying hollow structures, such as concave, continuous depressions (in the manner, for instance, of “longitudinal grooves”), cutouts or individual holes, on the surface of each thread. This can be done either during the manufacture of the threads—for example, using suitable extrusion profiles or spinerets—or else in an aftertreatment: for example, chemically by means of etching or coating, mechanically by means of scoring or roughening, or by means of thermal ablation. This, of course, likewise embraces threads constructed from a plurality of individual filaments, the hollow spaces on the surface of the threads being produced between individual filaments of a thread as a result of imperfect conformation of the filaments.

In order on the one hand to permit adequate fluid transport but on the other hand not too severely to impair the adhesive properties, provision is made, in a preferred embodiment, for the hollow spaces for transporting the fluid to have a diameter in the range from about 0.5 μm to about 5 μm, preferably in the range from about 1.5 μm to about 3 μm. Depending on field of application and selection of adhesive, however, other dimensions are also possible. The corresponding embodiment of the hollow spaces may be achieved through a suitable selection of the thread structure. The hollow spaces may, for example, be grooves or the like that run along the thread of the thread structure. In the case of such an embodiment, the diameter of the hollow space then corresponds to the depth of the groove.

In particular it is sensible if, when the adhesive layer is applied to the substrate, the hollow space is formed in each case between the adhesive layer and the substrate. This would be the case, for instance, if the hollow space were still not present in the adhesive layer prior to the bonding of adhesive layer and substrate, but the thread structure was adapted such that the hollow space is formed immediately on bonding of the adhesive layer to the substrate and was then present permanently in the adhesive bond. This is the case, for example, when the threads of the thread structure in the channel element are placed onto the highly viscous adhesive and not fully embedded in it. When the adhesive layer is bonded to the substrate, the threads, admittedly, do press into the adhesive layer, but, as a result of the surface tension and viscosity of the adhesive, a hollow space is formed between the threads and the adhesive, this hollow space then being closed off on one side by the substrate. An inventive adaptation in this case consists in equipping the surface of the threads such that they are not greatly wetted by the highly viscous adhesive and join only poorly to it, something which can be achieved, for instance, through the choice of the material of the threads or through separate coating of the threads. By this means, on introduction into the adhesive, the threads are not fully surrounded by the adhesive, and, in the course of adhesive bonding, a double hollow structure aligned parallel to the threads on this surface is able to form on both sides of a thread.

In addition it is advantageous for the hollow space to be disposed in each case in the interior of the at least one thread. This ensures a particularly stable channel structure in the channel element, which remains uninterrupted even in the case of low-viscosity adhesives. This is something which can be achieved, for example, when a thread is used which is hollow internally. Hollow threads of this kind that can be used include all typical internally hollow threads, including those commonly used as insulation materials, examples being hollow fibers such as Hollofil, Quallofil, Thermolite, and Coolmax (each from DuPont) or Thinsulate (3M) and Polarguard (Invista). It is particularly advantageous here if the thread has hollow spaces both on its inside and on its outside, since by this means it is possible to combine the advantageous effects of both embodiments. A structure of this kind has, for instance, a thread which is composed of a plurality of filaments and in which the filaments have been twisted with respect to one another. External hollow spaces are located in this case at the outside, between the individual filaments, whereas internally in the thread, between the individual filaments, there are likewise hollow spaces which may be suitable for fluid transport. This, however, presupposes that the adhesive does not fully enclose or at least not firmly adhere to the threads generated from twisted individual filaments, since otherwise it would not be possible for there to be the inventively essential adaptation of the threads—namely that of having at least temporarily a hollow space. More particularly it is favorable in this case if the at least one thread has at least one opening, perpendicularly to the principal thread direction, with a radial component that joins the exterior of the thread to the hollow space in the interior of the thread. An opening of this kind with a radial component comprises a cutout of arbitrary cross section which is not formed exclusively parallel to the principal direction of a thread, and which is sufficiently deep to create a join between the exterior of the thread and the interior of the thread. An opening of this kind offers the advantage that a fluid in the adhesive layer is able with particular simplicity to enter the hollow transport structure of the interior hollow space. This opening may be present in the thread from the outset, as in the case where threads comprising twisted individual filaments are used, where the space between individual filaments may serve simultaneously as an opening into the interior of the thread, provided the filament surface is designed accordingly. Likewise it is possible for the opening to be produced in an aftertreatment of the threads, such as thermally, in the case of pointwise perforation of hollow fibers by means of a laser. In this context it is practical to choose the spacing of these radial openings in the principal direction of the thread such that the spacing falls within a size range that encompasses the simple spacing between two adjacent threads down to a tenth of this spacing.

It is advantageous if the thread structure is formed without thread crossover points and if the at least one thread has a thickness between 6% and 110% of the average thickness of the adhesive layer perpendicularly to its two-dimensional extent. If the thickness of the thread is smaller, then the dimensions of the hollow space become too small for adequate fluid transport via it to still be possible. Moreover, an increase in the thickness of the threads is also accompanied by a decrease in their mechanical robustness, with the consequence that, in the case of relatively low thread diameters, there is an increased risk of breaking of the thread in the course of processing, which could result in unwanted delays in the manufacturing operation. On the other hand, the thickness of the thread is limited by the average thickness of the adhesive layer perpendicularly to its two-dimensional extent. If the thread is significantly thicker than the adhesive layer, in other words the thickness averaged over the two-dimensional extent of the overall adhesive layer, then contact between adhesive layer and substrate when they are pressed together will be almost exclusively via the thread structure; as a result of this, there would be a drastic reduction in the bond strength of the adhesive layer on the substrate, as a result of the additional peeling force. If, on the other hand, the thickness chosen for the thread is less than 110% of the average thickness of the adhesive layer, the contact area between the adhesive layer on the one hand and substrate on the other hand remains sufficiently great to ensure effective attachment of the adhesive layer on the substrate, more particularly when the thread itself still yields under gentle pressure, such as when an internally hollow thread is used.

Furthermore, it is also advantageous if the thread structure has thread crossover points and the threads have a thickness between 3% and 55% of the average thickness of the adhesive layer perpendicularly to its two-dimensional extent. Thread crossover points mean that there are two or more threads, not running parallel to one another, which intersect in their course. Nevertheless, the threads are each aligned substantially parallel to the two-dimensional extent of the adhesive layer; that is, they do not extend vertically up and down.

As well as structural reinforcement of the channel element in the adhesive, the use of crossed threads offers the advantage that a bubble of fluid can be transported via the channel system of the thread structure to the nearest edge of the adhesive layer over very short paths, since the nodal points create a multiplicity of short paths. This requires, furthermore, that the channel system be at least temporarily uninterrupted in particular at the intersection points. For this it is necessary for the hollow space of a thread to be in direct contact with that of the intersecting thread, or else for the barrier between the hollow space of a thread and that of the intersecting thread to be so small that on transport from one thread the fluid is easily able to overcome the barrier and to cross over to an intersecting thread.

In order on the one hand to have sufficient mechanical stability but on the other hand not excessively to reduce the flexibility of the adhesive layer, furthermore, it is advantageous if the at least one thread has a thickness of between 10 μm and 60 μm.

Furthermore, the invention allows the use of the above adhesive layer to produce a bubble-free adhesive bond. For this purpose the adhesive layer is applied directly to the surface of a substrate or else to a sheetlike structure, more particularly a flexible sheetlike structure such as an adhesive sheet, an adhesive tape or an adhesive label, for instance, which can be designed in typical fashion, as for example with carrier or carrierless (i.e., without a separate carrier). More particularly the invention allows the use of the adhesive layer to produce a bubble-freely bonding sheetlike structure of this kind.

The bubble-freely bonding sheetlike structure provided in accordance with the invention comprises a functional region and an adhesive region. Sheetlike structures of this kind may take various forms, such as a tape, label or sheet, for example.

The adhesive region, for its part, comprises the bubble-freely bonding adhesive layer described above. It is joined to the functional region, the join being able to be produced by way of any desired joining techniques, most simply by adhesive bonding of the adhesive layer on the functional region to the side of the adhesive layer opposite the bond face, or else by purposive chemical linking of the functional region to the adhesive region, for which purpose the functional region and/or the adhesive region may be chemically adapted by modification of the surface. A functional region in accordance with the invention comprises a region which has individual functional elements that give the sheetlike structure a function that goes beyond mere adhesive bonding to the substrate.

By way of example, a functional element of this kind may represent a carrier, for the purpose of giving the sheetlike structure mechanical stability overall. A carrier of this kind may be composed of any desired, typical materials, as for example of polymers such as polyester, polypropylene, polyethylene, polyamide or polyvinyl chloride, of woven, knitted, laid or nonwoven fabrics, paper, foams, and the like, or else of laminates of these materials. Such a carrier may be configured as a carrier joined permanently to the adhesive region, for conventional adhesive sheets and adhesive tapes, for example, or else may be composed of a temporary carrier, which in use is joined to the adhesive region only for a certain time, as for example for the application of the adhesive sheetlike structure to a substrate, and thereafter is removed again. Examples of temporary carriers of this kind are liners, more particularly in-process liners, of the kind typical in the adhesive industry, such as siliconized release papers.

A functional region may also be composed, furthermore, of a second adhesive region, such as a second adhesive region whose adhesive properties are modified relative to those of the first adhesive region, in order to obtain better adhesion on a different, second substrate. Sheetlike structures of this kind can then find use, for instance, as adhesive transfer tapes. It is of course possible for a functional region also to have two or more individual functional elements of this kind, such as a permanent carrier, on which a second adhesive region is applied that is lined by a temporary carrier. Typical constituents of such functional regions are, for instance, one or more plies of films, woven fabrics, nonwoven fabrics, foams, depot structures for particular additives or actives, and nonstick systems.

Finally the invention provides methods of producing the above bubble-freely bonding sheetlike structure. One of these methods of the invention comprises the steps of applying the adhesive to the functional region and subsequently applying the thread structure to the side of the adhesive that faces away from the functional region. Accordingly, then, the adhesive is first applied to the functional region, for instance by coating it onto a carrier, and then the thread structure comprising at least one thread is applied to the side of the adhesive that is not covered by the functional region. This application may consist in a simple placement, in a partial embedment, by means for instance of a pressure-application roll, or in an embedment, as for instance when the sheetlike structure with thread thereon is tautly wound, thereby embedding the thread into the adhesive, or else be carried out by other typical methods. The two steps of the method need not necessarily follow one another directly; instead, there may also be other steps taking place inbetween, such as a modification of the surface of the adhesive layer, for example.

The invention embraces the application of a thread structure composed of a plurality of threads, though it is particularly advantageous if the at least one thread is applied in individualized form to the adhesive. By this means it is possible to determine the position of each thread exactly on the adhesive and so to ensure that the spacing between adjacent threads is uniform and sufficiently great. In this way it is ensured that fluid transport from each two-dimensional territory of the sheetlike structure takes place with uniform ease, and that the sheetlike structure at the same time attaches effectively to the substrate.

A further method of the invention comprises the steps of applying the thread structure to a temporary carrier, subsequently applying the adhesive to the thread structure on the temporary carrier, and subsequently applying the functional region to the side of the adhesive facing away from the temporary carrier. This offers an advantage more particularly when the sheetlike structure in the adhesive layer is to exhibit a thread structure with an individually determined arrangement, and this arrangement of individual threads on the temporary carrier is to be constructed directly. This is of advantage, furthermore, if the aim is to obtain a sheetlike structure having a surface which finishes flush, the application of such a structure dictating no possibility for variation in the thickness of the sheetlike structure, such as in the case of the fixing of printing plates in flexographic printing, for instance. Here as well the steps of the method need not follow one another directly; instead, further method steps may be executed inbetween.

It is particularly advantageous in this context if the structure of the thread structure in this arrangement is fixed even on application to the temporary carrier. This is something which can be achieved, for instance, when the top face of the temporary carrier, prior to the application of the thread structure, is given an adhesion-boosting modification on one side, and the thread structure is applied to the adhesion-boostingly modified side of the temporary carrier. Boosting adhesion in this way is necessarily a boosting of the adhesion of the adhesive and of the thread structure on the temporary carrier, that in overall terms is so small that the adhesive layer can be detached from the temporary carrier without residue. It is likewise advantageous if, before the thread structure is applied, one side of the temporary carrier is given an adhesion-reducing modification and the thread structure is applied to the side of the temporary carrier that has not been given the adhesion-reducing modification. Adhesion reduction of this kind includes any reduction in the adhesion of the adhesive and of the thread structure to the temporary carrier. In this way, the residue-free unwinding of an adhesive sheetlike structure wound in roll form, and hence its usefulness as well, is significantly improved. Furthermore it may also, of course, be of advantage if both sides of the temporary carrier are given an adhesion-reducing design, thereby making it possible additionally to achieve effective detachment of the completed sheetlike structure from the temporary carrier. In this case the thread structure, prior to application of the adhesive, can be placed, under tension, for instance, onto the one adhesion-reducingly modified side of the temporary carrier.

Following the application of the thread structure, the adhesive layer can then be applied, by means for example of coating or else by means of bringing the thread-treated carrier together with an adhesive layer which has been spread out beforehand, using a pressure-application roller.

In the text below, the invention will be described in greater detail, with reference to the figures. Regarding these figures:

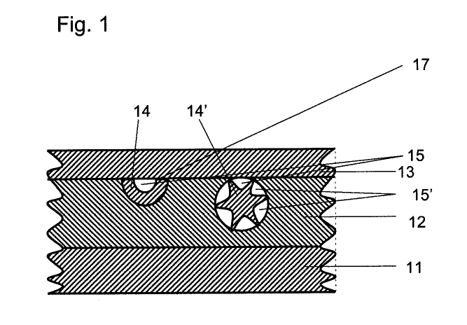

FIG. 1 shows a schematic cross section through a bond of a substrate to an adhesive sheetlike structure which comprises a carrier and an adhesive layer which has a channel element comprising monofil threads with hollow spaces on the outside;

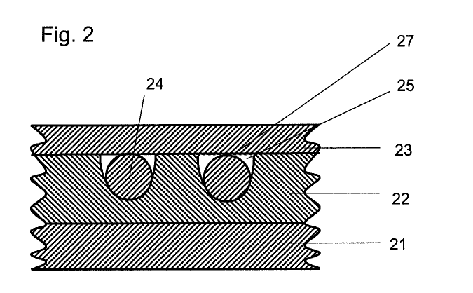

FIG. 2 shows a schematic cross section through a further embodiment of a bond of a substrate to an adhesive sheetlike structure which comprises a carrier and an adhesive layer which has a channel element comprising monofil threads with hollow spaces on the outside;

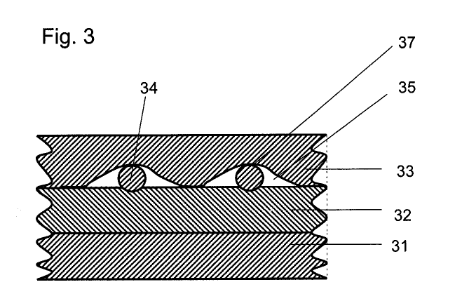

FIG. 3 shows a schematic cross section through a further embodiment of a bond of a substrate to an adhesive sheetlike structure which comprises a carrier and an adhesive layer which has a channel element comprising monofil threads with hollow spaces on the outside;

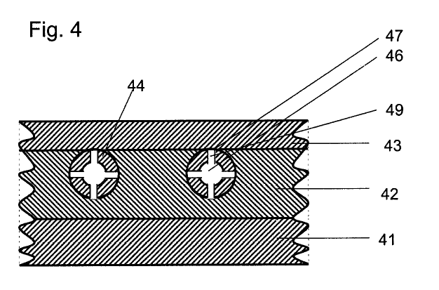

FIG. 4 shows a schematic cross section through a bond of a substrate to an adhesive sheetlike structure which comprises a carrier and an adhesive layer which has a channel element comprising monofil threads with hollow spaces in the interior and also with additional radial openings;

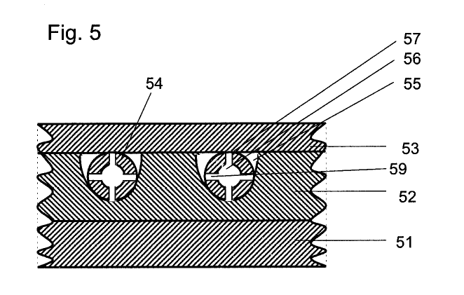

FIG. 5 shows a schematic cross section through a bond of a substrate to an adhesive sheetlike structure which comprises a carrier and an adhesive layer which has a channel element comprising monofil threads with hollow spaces on the outside and in the interior and also with additional radial openings;

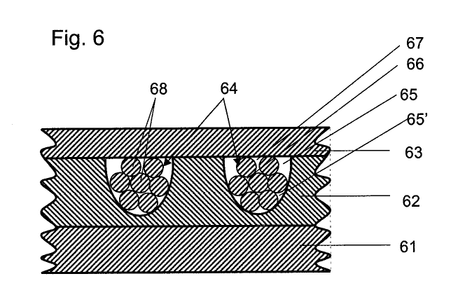

FIG. 6 shows a schematic cross section through one embodiment of a bond of a substrate to an adhesive sheetlike structure which comprises a carrier and an adhesive layer which has a channel element comprising polyfil threads with hollow spaces on the outside and in the interior;

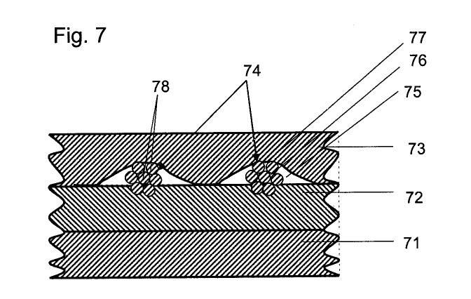

FIG. 7 shows a schematic cross section through a further embodiment of a bond of a substrate to an adhesive sheetlike structure which comprises a carrier and an adhesive layer which has a channel element comprising polyfil threads with hollow spaces on the outside and in the interior;

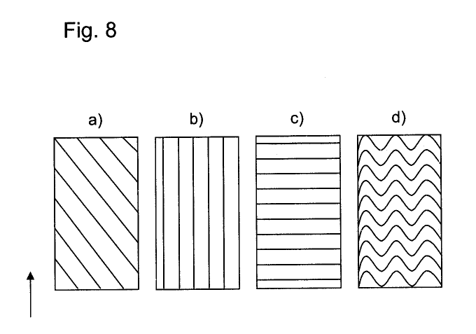

FIG. 8 shows four schematic plan views of an adhesive layer with different embodiments of a thread structure formed without thread crossover points; and

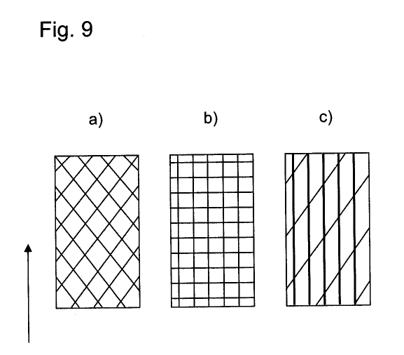

FIG. 9 shows three schematic plan views of an adhesive layer with different embodiments of a thread structure having thread crossover points.

FIG. 1 shows a sheetlike structure having a functional region, which consists of a carrier 11, and having an adhesive region with an adhesive 12. The sheetlike structure is bonded to a substrate 13. Inserted in the adhesive 12 is a channel element comprising threads 14, 14′. The threads 14, 14′ take the monofil form of individual strands and are composed of extruded polymer filaments which during manufacture have each been given a particular cross-sectional profile. In this case the threads 14, 14′ are inserted such that they finish virtually flush with the outside of the adhesive 12. The hollow profiles chosen for the thread cross sections result in the formation of hollow spaces 15, 15′ on the outside of the monofilaments in the course of bonding or else as early as in the course of insertion of the threads 14, 14′ into the adhesive 12; removal of the fluids from the adhesive bond can be effected through the said hollow spaces. For this purpose, the thread 14 shown in the left-hand part of FIG. 1 has the form of a trough, resulting, on bonding, in a fluid channel 15 between the thread 14 and the substrate 13. Thread 14, furthermore, is of adhesion-reducing design at the contact area 17 between the thread 14 and the substrate 13. As a result of this, the thread 14 itself does not adhere to the substrate 13, and so, during transport of a bubble of fluid via the hollow profile of the thread 14, a further hollow space can be formed directly at the contact area 17, by the thread 14 lifting locally from the substrate 13 at that point. If, then, the volume of fluid transported has passed through the channel element at this point, the thread 14 at the contact area 17 lies against the substrate 13 again, as a result of the inherent tension of the sheetlike structure. Consequently this further hollow space represents a temporary hollow space.

The thread 14′ shown in the right-hand part of FIG. 1, in contrast, has an irregular-starlike cross section. In this case, as early as during insertion into the adhesive 12, a multiplicity of fluid channels 15′ are formed, since, because of the viscosity and surface tension of the adhesive 12 on the one hand and the dimensions of the “arms” of the star on the other, wetting of the outer faces of the thread 14′ with adhesive 12 between the arms does not take place. As a result of the orientation of the thread 14′ in the adhesive layer, a further fluid channel 15 comes about during bonding between the thread 14′ and the substrate 13.

FIG. 2 shows a sheetlike structure having a functional region, which consists of a carrier 21, and having an adhesive region with an adhesive 22. The sheetlike structure is bonded to a substrate 23. Inserted in the adhesive 22 is a channel element comprising threads 24. The threads 24 take the monofil form of individual, full-area strands. The threads 24 are embedded in such a way that they finish virtually flush with the outside of the adhesive 22—to be more precise, with the outside of the adhesive 22 prior to the insertion of the threads 24. When the threads 24 are inserted into the adhesive 22, parts of the surface of the threads 24 are not wetted by the adhesive 22, owing to the viscosity and surface tension of the adhesive 22 on the one hand and to the chosen, circle-like cross section of the thread 24 on the other. At these points, during bonding, fluid channels 25 are formed between the thread 24 and the substrate 23. Furthermore, the contact area 27 between the thread 24 and the substrate 23, thread 24 is of adhesion-reducing design. As a result of this, the thread itself does not adhere to the substrate, and so, during transport of a bubble of fluid via the permanent fluid channels 25, a further hollow space can be formed directly at the contact area 27, by the thread 24 lifting locally from the substrate at that point. If, then, the volume of fluid transported has passed through the channel element locally at this point, the thread 24 at the contact area 27 lies against the substrate 23 again, as a result of the inherent tension of the sheetlike structure. Consequently this further hollow space likewise represents a temporary hollow space.

FIG. 3 shows a similar design to FIG. 2, namely a sheetlike structure having a carrier 31 and an adhesive 32 on a substrate 33. In the adhesive 32 there are monofil threads 34, but they do not finish flush with the outside of the adhesive 32 before the threads 34 are inserted, but instead project beyond this outside face. A design of this kind is particularly advantageous in the case of substrates which at least in the region of the contact area 37 itself are not rigid but, rather, are deformable or soft. Here again, when the threads 34 are inserted into the adhesive 32, fluid channels 35 are formed between the threads 34 and the substrate 33. Moreover, at the adhesion-reducingly designed contact area 37 between the thread 34 and the substrate 33, there may occur, temporarily, a further hollow space, it also being possible in addition for the substrate to lift from the thread as a result of the inherent nature of the substrate.

FIG. 4 shows a sheetlike structure having a functional region comprising a carrier 41 and having an adhesive region with an adhesive 42. The sheetlike structure is bonded to a substrate 43. Inserted in the adhesive 42 is a channel element comprising threads 44. The threads 44 take the monofil form of individual strands, more specifically in the form of hollow fibers which within their interior have an interrupted hollow space 46. This hollow space 46 communicates via radial bores 49 with the region located around the thread 44. The diameters of the radial openings 49 are in this case chosen so that they are not wetted by the adhesive that is used and thus do not become clogged. Additionally, the insides of these openings are of friction-reducing design. Also apparent from FIG. 4 is the fact that, in this particular embodiment, the radial openings 49 are located in a plane perpendicular to the principal axis of the thread 44 at an angle of 90° to one another. An arrangement of this kind is referred to here as a crown of openings. In the principal direction, the thread 44 has a plurality of crowns of openings at a distance from one another. On an overall basis, the threads 44 are embedded such that they finish virtually flush with the outside of the adhesive 42 before the threads 44 are inserted. The outside of the thread 44 is surrounded by the adhesive; only in the region of the contact area 47 is the outside of the thread 44 free from adhesive 42. At this point, instead, the thread 44 is of adhesion-reducing design, and so with this system as well it is possible for temporary fluid channels to form at the contact area 47.

A design similar to the system shown in FIG. 4 is shown by FIG. 5. Inserted into the adhesive 52 on the carrier 51, here again, are hollow fibers as threads 54, each having an internal hollow space 56 and radial bores 59. The threads 54 are likewise embedded so that they finish virtually flush with the outside of the adhesive 52 before the threads 54 are inserted. When the threads 54 are inserted into the adhesive 52, parts of the surface of the threads 54 are not wetted by the adhesive 52, on account of the viscosity and surface tension of the adhesive 52 on the one hand and of the chosen cross section of the threads 54 on the other. At these points, in the course of bonding, outer fluid channels 55 are formed between the thread 54 and the substrate 53. Here likewise, temporary fluid channels are formed at the non-adhesive contact area 57 between the thread 54 and the substrate 53.

FIG. 6 shows a sheetlike structure having a functional region, which is composed of a carrier 61, and having an adhesive region with an adhesive 62. The sheetlike structure is bonded to a substrate 63. Inserted in the adhesive 62 is a channel element comprising threads 64. The threads 64 take the form of single polyfil strands each composed of a plurality of filaments 68. Owing to the viscosity and surface tension of the adhesive 62 on the one hand and to the chosen polyfil construction of the threads 64, those regions of the outside of the threads that are located near to the contact region of the individual filaments 68 are not wetted. Fluid transport is possible via the outer hollow spaces 65′ which come about as a result. Furthermore, there are hollow spaces 66 in the interior of the threads that are outwardly limited by the individual filaments 68. Via these channels 66 as well, fluid transport is possible, the fluid passing from the outside into these channels, by creating temporary radial openings for passage between the individual filaments. The threads 64 are embedded in the adhesive 62 such that it finishes virtually flush with the outside of the adhesive 62 prior to the insertion of the threads 64. When the threads 64 are inserted into the adhesive 62, this keeps regions of the surface of the threads 64 free from adhesive. At these points, in the course of bonding, additional outer fluid channels 65 are formed between the thread 64 and the substrate 63. Furthermore, temporary fluid channels are formed at the nonadhesive contact area 67 between the thread 64 and the substrate 63.

FIG. 7 shows a modification of the system depicted in FIG. 6, for bonding to at least partially deformable or yielding substrates. This sheetlike structure as well comprises an adhesive 72 on a carrier 71, in which polyfilaments have been inserted as threads 74, each having internal hollow spaces 76 between the individual filaments 78. In this case, however, the threads 74 are embedded such that they are introduced only partly into the adhesive 72 and therefore protrude beyond the outside of the adhesive 72 before the threads 74 are inserted. Here again, when the threads 74 are inserted into the adhesive 72, regions of the surface of the threads 74 are kept free from adhesive. At these points, in the course of bonding, outer fluid channels 75 are formed between the thread 74 and substrate 73. Furthermore, temporary fluid channels are formed at the nonadhesive contact area 77 between the thread 74 and the yielding substrate 73.

FIG. 8 and FIG. 9 show plan views of adhesive layers with different embodiments of thread structures, in section. The two-dimensional orientation of the adhesive layers runs in each case in the plane of the drawing; the production direction is indicated at the bottom left by an arrow.

FIG. 8 depicts arrangements in which the threads of the thread structure are disposed without thread crossover points, in each case at a uniform distance from one another in parallel. In FIG. 8a) the threads run in a direction oblique to the production direction; in FIG. 8b) the threads run in the production direction; in FIG. 8c) the threads run transverse to the production direction; and in FIG. 8d) the threads run in a wave shape whose preferential direction is transverse to the production direction.

FIG. 9 shows arrangements in which the threads of the thread structure have been designed with thread crossover points. In this case the thread structures each comprise two sublattices which are arranged at an angle to one another. The individual threads in each sublattice, in the embodiment shown, each run at a uniform distance from one another in parallel. Moreover, the threads each run substantially parallel to the two-dimensional extent of the adhesive layer, in other words not vertically up and down. In FIG. 9a) the sublattices each run not only obliquely to one another but also obliquely to the production direction; in FIG. 9b) one sublattice runs in the production direction and the other transversely thereto; and in FIG. 9c) one sublattice runs in the production direction and the other obliquely thereto. Whereas in FIGS. 9a) and b) each sublattice has the same thread spacing, in FIG. 9c) the thread spacings of the two sublattices are different. Here, furthermore, the thicknesses of the thread cross sections of the two sublattices are different.

For the purpose of illustrating the invention a description is given below, purely illustratively, of an example of the system of the invention and method of producing it.

A solvent-based pressure-sensitive acrylate adhesive is applied with a coat weight of 40 g(solids)/m² to one side of a double-sidedly corona-pretreated, tapelike carrier sheet of polyester (Hostaphan RN23; Mitsubishi) with a thickness of 23 μm. Thereafter the adhesive is crosslinked and dried. Placed atop the side of the adhesive facing away from the carrier sheet, subsequently, is a first thread structure comprising glass fiber (EC9-34S20 2/4S; Valmieras Stikla Skiedra), parallel to the production direction, with a mid-point spacing of 5 mm. Then a double-sidedly siliconized release paper is laminated, as an adhesion-reducing temporary carrier, to the side of the adhesive that has been provided with the thread structure. The pressure for this operation is chosen such that the thread structures are embedded into the pressure-sensitive adhesive to approximately 95% of their thickness perpendicularly to the two-dimensional extent of the carrier sheet. Then, on the side of the carrier sheet facing away from the pressure-sensitive adhesive, a second pressure-sensitive acrylate adhesive is applied with a coat weight of 20 g(solids)/m². Finally, a polyethylene foam with a closed-cell structure, a thickness of 430 μm and a density of 250 kg/m³ is laminated to the side of the second pressure-sensitive adhesive opposite the carrier sheet. In this way a laminated multiple carrier system on a release paper is obtained, its top face covered with foam.

A second thread structure, analogous to the first thread structure, is placed onto a second, double-sidedly adhesion-reducing siliconized release paper, parallel to the production direction, with a mid-point distance of 5 mm, under tension, and in this state the assembly is coated with a third, solvent-based pressure-sensitive acrylate adhesive, with a coat weight of 60 g(solids) /m², and so the side of the second thread structure that faces away from the second temporary carrier is covered over the full area. The viscosity of the pressure-sensitive adhesive in this case is chosen such that the noncrosslinked third pressure-sensitive adhesive does not surround the second thread structure in its entire circumference, but instead such that the second thread structure remains in direct contact with the release paper.

Finally, the foam-covered side of the above multiple carrier system is laminated onto the side of the third pressure-sensitive adhesive that faces away from the second thread structure. The second release paper, lastly, is removed, and the functional adhesive tape produced in this way is wound up in roll form.

1. A bubble-freely bonding adhesive layer compising an adhesive and a channel element, said adhesive layer further comprising at least one bubble-freely adhesive face,
wherein
in that the channel element is so formed as to have at least temporarily a hollow space adapted for the transport of fluid,
in that the channel element comprises for this purpose a thread structure with at least one thread,
in that the channel element and the thread structure are oriented substantially parallel to the two-dimensional extent of the adhesive layer, and
in that a part of the surface of the thread structure forms a part of the surface of the side of the adhesive layer that is the at least one bubble-freely bonding adhesive face of the adhesive layer.

2. The adhesive layer of claim 1, wherein the at least one thread lies completely free over its entire longitudinal extent along the principal thread direction.

3. The adhesive layer of claim 1, wherein the hollow space is disposed in each case on the outside of the at least one thread.

4. The adhesive layer of claim 3, wherein the hollow space is formed in each case between the adhesive layer and the substrate when the adhesive layer is applied to the substrate.

5. The adhesive layer of claim 1, wherein the hollow space is disposed in each case in the interior of the at least one thread.

6. The adhesive layer of claim 5, wherein, perpendicularly to the principal thread direction, the at least one thread has in each case at least one opening with a radial component which joins the exterior of the thread to the hollow space in the interior of the thread.

7. The adhesive layer of claim 1, wherein the at least one thread comprises in each case a single filament.

8. The adhesive layer of claim 1, wherein the at least one thread comprises in each case two or more filaments.

9. The adhesive layer of claim 1, wherein the thread structure comprises two or more threads.

10. The adhesive layer of claim 9, wherein the thread structure has thread crossover points and the threads have a thickness of between 3% and 55% of the average thickness of the adhesive layer perpendicularly to its two-dimensional extent.

11. The adhesive layer of claim 1, wherein the thread structure is formed without thread crossover points and the at least one thread has a thickness of between 6% and 110% of the average thickness of the adhesive layer perpendicularly to its two-dimensional extent.

12. The adhesive layer of claim 1, wherein the at least one thread has a thickness of between 10 μm and 60 μm.

13. The adhesive layer of claim 1, wherein the channel element is so formed as to have permanently a hollow space adapted for the transport of fluid.

14. A method of producing a bubble-free bond, comprising adhering the adhesive layer of claim 1 to a substrate and thereby producing a bubble-free bond.

15. A bubble-freely bonding sheetlike structure comprising a functional region and an adhesive region joined to the functional region, wherein the adhesive region comprises an adhesive layer of claim 1.

16. A method of producing a bubble-freely bonding sheetlike structure, comprising applying an adhesive layer as claimed in claim 1 to a functional region and thereby producing a bubble-freely bonding sheetlike structure.

17. The method of claim 16, which further comprises subsequently applying the thread structure to the side of the adhesive layer that faces away from the functional region.

18. The method of claim 17, wherein the at least one thread is applied in individualized form to the adhesive.

19. The method of claim 16, which further comprises the following steps:
applying the thread structure to a temporary support,
subsequently applying the adhesive to the thread structure on the temporary support, and
subsequently applying the functional region to the side of the adhesive that faces away from the temporary support.

20. The method of claim 19, wherein, before the thread structure is applied, one side of the temporary support is given an adhesion-reducing modification and the thread structure is applied to the side of the temporary support that has not been given the adhesion-reducing modification.

21. The method of claim 19, wherein, before the thread structure is applied, one side of the temporary support is given an adhesion-boosting modification and the thread structure is applied to the side of the temporary support that has been given the adhesion-boosting modification.
